(19) United States
(12) Patent Application Publication
(10) Pub. No.: US 2025/0220088 A1
(43) Pub. Date: Jul. 3, 2025

(54) SERVICE REGISTRY FUNCTION FOR DISCOVERING SERVICE INSTANCES

(71) Applicant: Intel Corporation, Santa Clara, CA (US)

(72) Inventors: Zongrui Ding, Portland, OR (US); Qian Li, Beaverton, OR (US); Xiaopeng Tong, Beijing (CN); Alexandre Saso Stojanovski, Paris (FR); Thomas Luetzenkirchen, Taufkirchen (DE); Sudeep K. Palat, Cheltenham (GB); Abhijeet Ashok Kolekar, Hillsboro, OR (US); Sangeetha L. Bangolae, Portland, OR (US); Youn Hyoung Heo, Sunnyvale, CA (US)

(21) Appl. No.: 18/853,043

(22) PCT Filed: Apr. 27, 2023
(86) PCT No.: PCT/US2023/020113

§ 371 Date: Sep. 30, 2024

Related U.S. Application Data
(60) Provisional application No. 63/338,143, filed on May 4, 2022.
(60) Provisional application No. 63/340,749, filed on May 11, 2022.

(51) Int. Cl. H04L 67/51; H04L 9/40; H04L 67/562

(52) U.S. Cl. CPC H04L 67/51; H04L 63/083; H04L 67/562

(57) ABSTRACT

An apparatus and system of providing a service registry function (SRF) and service discovery in a 6G system are described. Registration procedures are provided for a service instance on a user equipment (UE) or in the 6G system to register to the SRF with or without a service mesh. The SRF provides a list of service instances based on criteria in service discovery inquiries from the UE or network function (NF) and notifies a subscribed party about a status change of a particular service instance. The service discovery enables the UE to discover a computing service instance in the 6G system by control plane service discovery to find a service orchestration and chaining function (SOCF) and user plane service discovery to find the computing service instance.

### PRIORITY CLAIM

This application claims the benefit of priority to U.S. Provisional Application Ser. No. 63/338,143, filed May 4, 2022, and U.S. Provisional Application Ser. No. 63/340,749, filed May 11, 2022, each of which is incorporated herein by reference in its entirety.

### TECHNICAL FIELD

Embodiments pertain to wireless communications. In particular, some embodiments relate to functionality in next generation (6G) cellular networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology. In particular, enhancements of 6G systems that provide computing/data services in addition to communication services continue to be developed.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates general message flow for UE service discovery for computing in accordance with some embodiments.

FIG. 4 illustrates a UE request service mesh configuration in accordance with some embodiments.

FIG. 5 illustrates service infrastructure control function (SICF) queries network repository function (NRF)/service registration function (SRF) for service discovery for service mesh configuration in accordance with some embodiments.

FIG. 6 illustrates service orchestration and chaining function (SOCF) discovery based on service mesh configuration in accordance with some embodiments.

FIG. 7 illustrates a service orchestration and chaining function (SOCF) service discovery negotiation procedure in accordance with some embodiments.

FIG. 8 illustrates a computing service function (Comp SF) as an ingress gateway (GW) for computing services in accordance with some embodiments.

FIG. 9 illustrates a Comp SF as a GW for routing user plane (UP) traffic to a service instance in accordance with some embodiments.

FIG. 10 illustrates a communication service function (Comm SF) as a GW for computing services in accordance with some embodiments.

FIG. 11 illustrates a B5G/6G Core Network Service based Architecture (SBA) with SRF in accordance with some embodiments.

FIG. 12 illustrates computing service instance registration in a cellular network in accordance with some embodiments.

FIG. 13 illustrates UE computing service registration in accordance with some embodiments.

FIG. 14 illustrates SRF service registration from an SICF based on a user plane service mesh in accordance with some embodiments.

FIG. 15 illustrates computing service subscription and notification in accordance with some embodiments.

FIG. 16 illustrates SRF service discovery in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

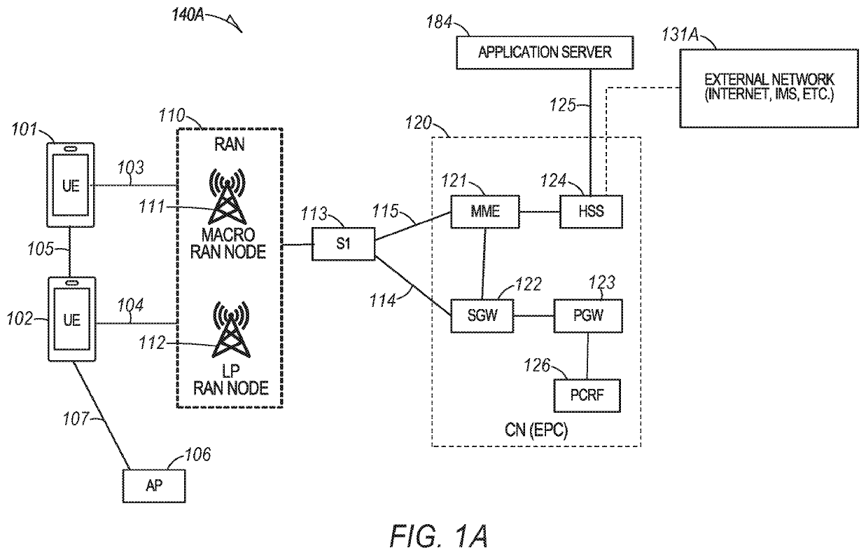

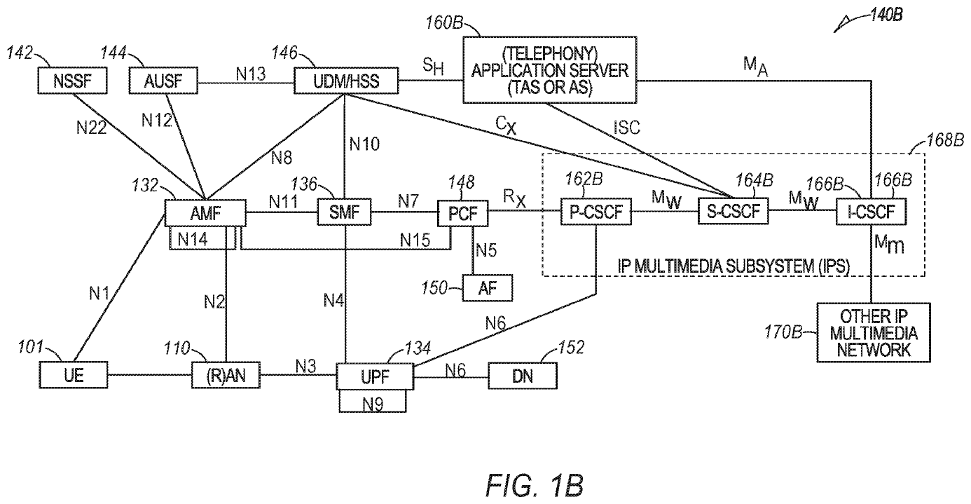

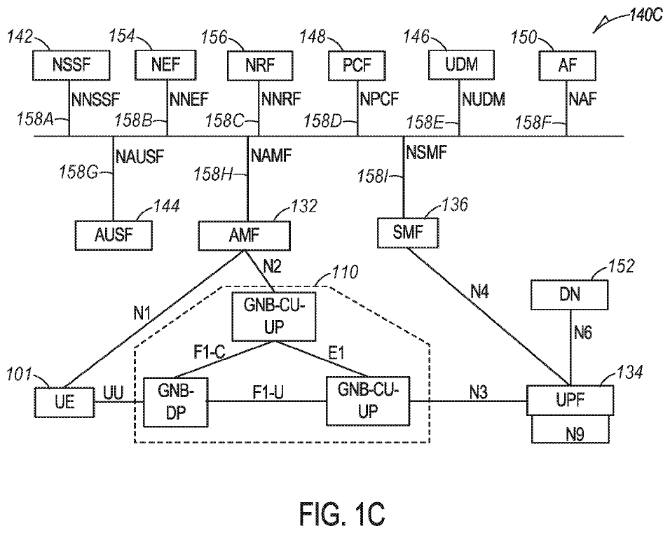

FIG. 1A illustrates an architecture of a network in accordance with some aspects. The network 140A includes 3GPP LTE/4G and NG network functions that may be extended to 6G and later generation functions. Accordingly, although 5G will be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHZ, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIOT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units-a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signalling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signalling connection and UE-associated services that are related to a single UE and are associated with a UE-associated signalling connection that is maintained for the UE.

The F1 interface may be disposed between the CU and the DU. The CU may control the operation of the DU over the F1 interface. As the signalling in the gNB is split into control plane and user plane signalling, the F1 interface may be split into the F1-C interface for control plane signalling between the gNB-DU and the gNB-CU-CP, and the F1-U interface for user plane signalling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as E2 nodes, base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signalling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The RAN 110 can include a plurality of nodes, such as gNBs and NG-eNBs (and may also be referred to as an NG-RAN or xRAN). The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

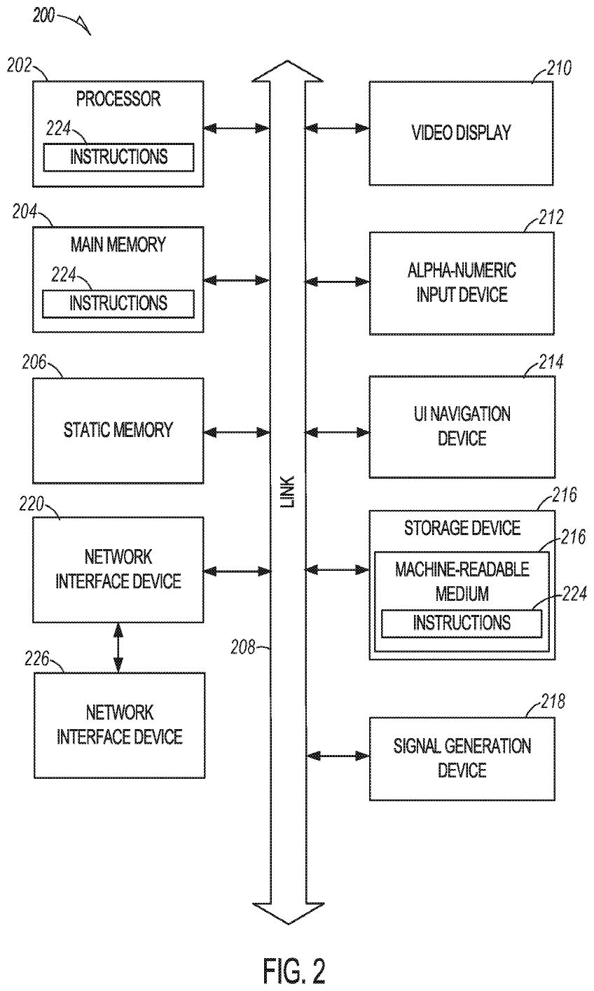

FIG. 2 illustrates a block diagram of a communication device in accordance with some embodiments, such as an evolved Node-B (eNB), a new generation Node-B (gNB) (or another RAN node), an access point (AP), a wireless station (STA), a mobile station (MS), or user equipment (UE), in accordance with some aspects and to perform one or more of the techniques disclosed herein. In alternative aspects, the communication device 200 may operate as a standalone device or may be connected (e.g., networked) to other communication devices. The communication device may be any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHZ), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHZ, 38.6-40 GHz, 42-42.5 GHZ, 57-64 GHZ, 71-76 GHZ, 81-86 GHz and 92-94 GHZ, etc), the ITS (Intelligent Transport Systems) band of 5.9 GHZ (typically 5.85-5.925 GHz) and 63-64 GHz, bands currently allocated to WiGig such as WiGig Band 1 (57.24-59.40 GHZ), WiGig Band 2 (59.40-61.56 GHz) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

As above, in 5G cellular networks, service discovery is generally performed by a UE through the UP as a result of Domain Name Server (DNS) inquiries. These inquiries return information such as IP address, port number, etc. of the application server, edge server or a datacenter frontend. With further cloudification, the 6G system natively can provide computing/data services in addition to communication services. Thus, the network has information about the services, e.g., computing functions, microservice instances as a result of an orchestration placement. A service mesh may be used to provide a configurable network infrastructure layer for microservices applications to facilitate service to service communications. These capabilities can further facilitate the service discovery in 6G networks.

The manner in which a UE discovers a targeted microservice with or without service mesh is described herein, as is the assistance provided by the 6G system to the UE service discovery procedure. In addition, interaction of the UE with the SOCF, SICF, and SRF to exchange service discovery related information is described herein, in addition to the identifiers for the UE to use to send data to a microservice in the cellular network-especially communication and computing data. Accordingly, a general service discovery procedure is described to enable the UE to discover a computing service instance in the 6G system. The general service discovery procedure describes two steps: Step 1: the control plane (CP) service discovery to find a SOCF; and Step 2: the UP service discovery to find the computing service instance. Different options are provided for Step 1 and Step 2 respectively considering the network configurations and capabilities such as whether the 6G system supports a service mesh.

As above, the service discovery includes two steps: Step 1: the service discovery for a UE to find a SOCF instance, which is referred to as CP service discovery herein; Step 2: the service discovery for a UE to find a computing service such as a micro service instance or function instance, which is referred to as UP service discovery herein.

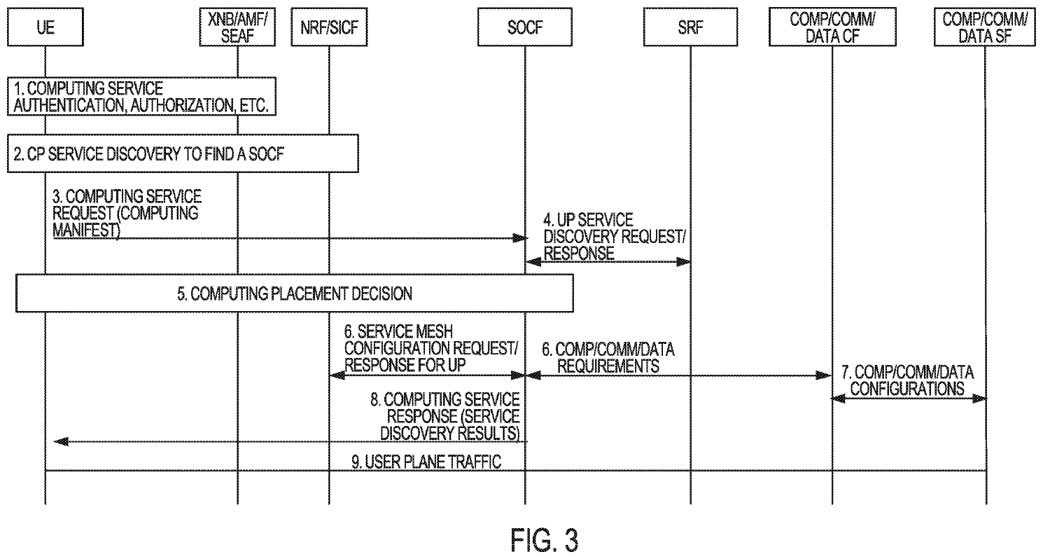

FIG. 3 illustrates general message flow for UE service discovery for computing in accordance with some embodiments. The general message flow for the microservice on a UE to communicate with another microservice in the network shown in FIG. 3 has a number of operations:

At operation 1, the UE sends a service registration message to the xNB (e.g., CU-CP), AMF or Security Anchor Function (SEAF) for service registration, authentication and authorization similar to the registration procedure described in clause 4.2.2 of 3GPP TS 23.502 (Procedures for the 5G System, Stage 2). In additional, the UE may include any credentials used to authenticate and authorize for the subscribed computing service.

At operation 2, the UE performs CP service discovery to find a SOCF. This may include multiple operations and be based on different options that are detailed in the CP Service Discovery Options below. Note that operations 1 and 2 can be combined.

At operation 3, the UE sends a service request to the SOCF for a computing service with the computing manifest including IDs to indicate the service (such as DNN, S-NSSAI, App ID, URL, etc.) with other related requirements on resource, location, software/hardware (SW/HW) capability, QOS, etc.

At operation 4, the SOCF sends a service discovery request to SRF and obtains the results of the service instances that meet the discovery criteria. The service request may include the IDs and requirements received in operation 3 to indicate the service. The service discovery response may include information such as the Comp/Comm/Data functions that related to the service instance and requirements on how to access the service. If no service instance is available, the SOCF may decide on launching up an instance and queries an NRF to find appropriate Comp/Comm/Data functions to interact following the procedures in clause 5.2.7.3 of 3GPP TS 23.502.

At operation 5, based on information such as the UE subscription, the UE computing manifest, the service discovery results, operator policies, etc., the SOCF makes a decision about the placement of the requested computing service. This may include launching a new service instance or reusing an existing service instance and generate the detailed requirements on Comp/Comm/Data CF/SFs for UE. Alternatively, the SOCF may send the service discovery results to the UE so that the UE can explicitly choose service instance(s) and inform the SOCF about this selection, as described in the UP service discovery herein. The UE can indicate the preference of the UE based service discovery to SOCF in operation 3.

At operation 6, the SOCF sends a request about the requirements to Comp/Comm/Data CFs, which are discovered or selected in operation 4. If the 6G system supports a service mesh, the SOCF sends a service mesh configuration request message to the SICF and the SICF may send back the information about service instances in the formed service mesh for the user plane.

At operation 7, the Comp/Comm/Data CF sends the request to configure the Comp/Comm/Data SFs. This can be discovered in operation 4 or further selected by the Comp/Comm/Data CFs. In operation 7, a communication bearer such as a PDU session is set up.

At operation 8, the SOCF sends a computing service response with the information received from the service discovery response in operation 7 to the UE about the service instance(s) that meet the service discovery criteria, such as requirements on how to access the service and related IDs (to be detailed in the UP service discovery herein). This information may already be sent during operation 5 if a UE based service discovery is performed.

At operation 9, based on the service discovery results, the UE can set up a session with the Comp SF so that a PDU session can be set up between the UE and the selected Comm SF, which steers the traffic to the target Comp SF.

Additional embodiments depend on whether there is service mesh in the 6G system and different IDs used for service discovery and communication.

### Co-Ordinations Between SICF, NRF and SRF for Service Discovery

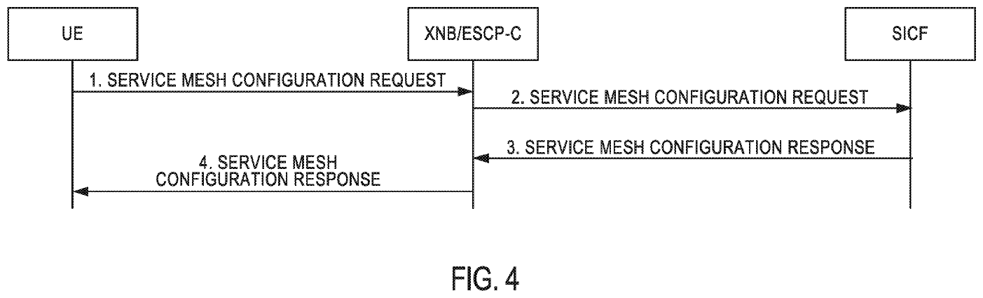

The NRF is the service registry for NFs in the 6G system as defined in 3GPP TS 23.502. The SRF is the service registry for computing services in the 6G system. When both the UE and the 6G system support a service mesh, a control plane service mesh and user plane service mesh can be formed. As a natural capability of the service mesh, the evolved service communication proxy-control plane (eSCP-Cs) and evolved service communication proxy-user plane (eSCP-Us) register the NFs or the computing service instances to the SICF. Therefore, the SICF may share the same database with the NRF/SRF for the CP/UP service mesh. Co-ordination among these functions may be desirable. FIG. 4 illustrates a UE request service mesh configuration in accordance with some embodiments.

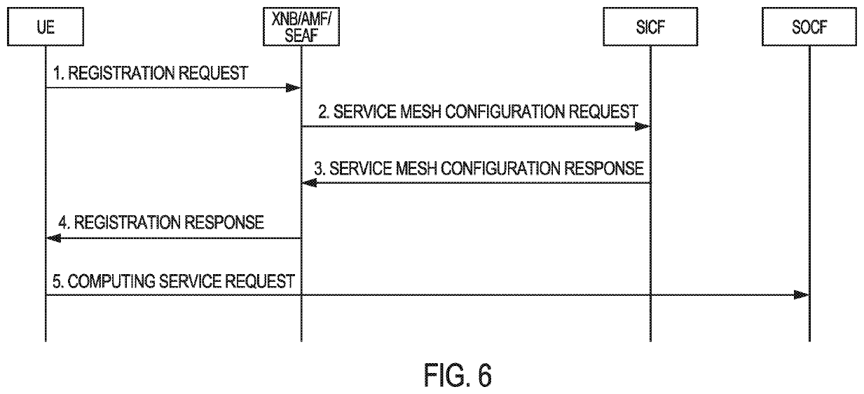

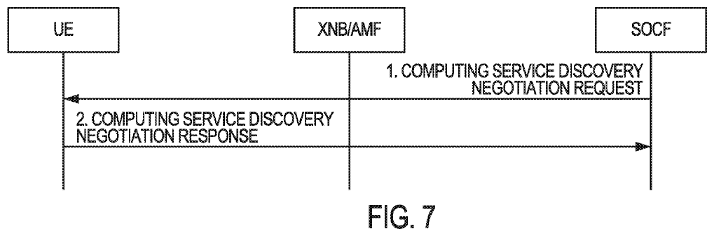

Option 1: SICF can provide service discovery service as part of the service mesh configuration as shown in FIG. 6. In this case, use of NRF or SRF may be avoided. The information about service discovery for NF instances (CP service discovery) can be requested by and sent to the AMF/SEAF from the SICF during the registration procedure and then sent to the UE in combination with the registration response. The information about service discovery for computing service instances (UP service discovery) can be requested by and sent to the SOCF from the SICF during the UE requesting a computing service, and then sent to the UE in a separate message in FIG. 7 or in combination with the computing service response in operation 2 of FIG. 3. The UE may directly send a service mesh configuration request to the SICF and get the service discovery related information in the service mesh configuration response after the CP/UP service mesh is established as shown in FIG. 4.

In FIG. 4, at operation 1 the UE sends a service mesh configuration request to the xNB. The request may include information such as UE identifiers, DNN, S-NSSAI, etc. and a configuration option indicating service discovery for computing instances.

At operation 2, the xNB forwards the service mesh configuration request to a SICF, which can be based on assignment to the UE or a previous CP service discovery. This message may also go through the eSCP-Cs.

At operation 3, the SICF sends the service mesh configuration response with the list of service instances for the UP service mesh, similar to operation 3 of FIG. 6.

At operation 4, the xNB sends the service mesh configuration response to the UE with the information about service instances.

Option 2: the NRF and SRF may provide the service discovery service without the SICF. Even the 6G system support service mesh, the CP and UP service discovery may not involve a SICF but rely on querying the NRF and SRF.

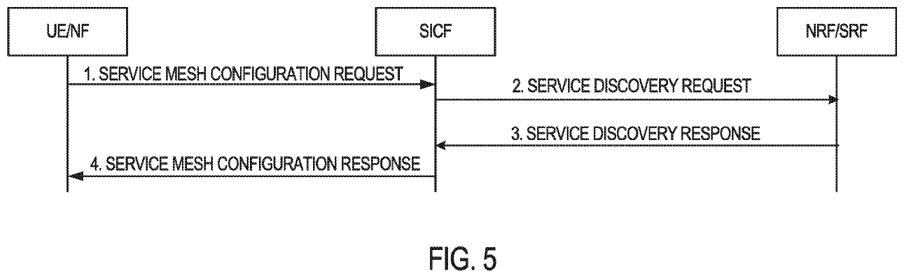

Option 3: the SICF may co-ordinate with the NRF/SRF to serve different UEs. For example, the SICF, NRF, and SRF may share the service registry so that when the SICF is queried, the SICF can further query the NRF and SRF to get the information about the NF or service instances as shown in FIG. 5. Note that policies are defined for how the SICF and NRF/SRF can access and modify the data to avoid any conflicts.

FIG. 5 illustrates SICF queries NRF/SRF for service discovery for service mesh configuration in accordance with some embodiments. At operation 1, the UE/NF sends a service mesh configuration request to SICF to configure a service mesh similar to operation 1 and 2 in FIG. 4. This message includes the UE identifiers and an indication on whether the CP or UP service mesh are to be configured and the related identifiers such as the DNN and S-NSSAI.

At operation 2, the SICF sends a request to the NRF for service discovery of NFs or SRF for service discovery of computing service instances with any discovery criteria.

At operation 3, the NRF/SRF responds with the list of NF or computing service instances based on the query criteria.

At operation 4, the SICF sends the service mesh configuration response to the UE/NF based on the service discovery results received from the NRF/SRF.

### CP Service Discovery Options at Operation 2 in FIG. 3

Option 1: The SOCF discovery may be based on assignment in operation 1 of FIG. 3 so that the SOCF ID is stored in the xNB/AMF/SEAF as part of the UE context. The ID used to decide the assignment may be the DNN, S-NSSAI, App ID, URL, vendor name, etc. When the UE is initiating a computing service request, the xNB/AMF/SEAF may forward the request to the assigned SOCF based on a mapping between SOCF ID to an ID such as IP address: port number. Additional load balancing may be achieved by assigning multiple SOCFs to a UE and then deciding on the target SOCF at the time of routing the request message.

Option 2: The SOCF discovery may be based on the NRF. When receiving a computing service request in operation 3, the xNB can query the NRF for an appropriate SOCF. In this case, operations 2 and 3 are switched in FIG. 3. In a stateful operation, the SOCF ID may be stored as part of the UE context and the rest of the operations are similar to Option 1. In a stateless operation, for each computing service request, the xNB may query the NRF in an asynchronized way. Different SOCFs may be selected for different computing service requests.

Option 3: The SOCF discovery may be based on the UE registration procedure combined with the SICF configuration procedure, as shown in FIG. 6 if the 6G system supports service mesh. In this case, operation 4 of FIG. 3 may be eliminated.

FIG. 6 illustrates SOCF discovery based on service mesh configuration in accordance with some embodiments. At operation 1, the UE sends a registration request to the AMF/SEAF as in clause 4.2.2 in 3GPP TS 23.502. In this message, the UE indicates the capability of service mesh and computing service support and may include appropriate credentials for service mesh, such as certificates.

At operation 2, the AMF/SEAF authenticates and authorizes the UE similar to clause 4.2.2 in 3GPP TS 23.502. The AMF/SEAF sends a request to the SICF to configure the service mesh on the UE. The request may include the UE IDs such as a Subscription Permanent Identifier (SUPI) and certificates.

At operation 3, the SICF sends a service mesh configuration response that includes a list of SOCFs with different credentials about capabilities, vendors, etc. In this case, the SICF may work with or without a NRF to obtain this information as described in 5.1.1 in the UP service discovery.

At operation 4, the AMF/SEAF sends the registration response to the UE including the information in the service mesh configuration response. This information includes the SOCF list.

At operation 4, the UE may select a SOCF based on the profiles received in operation 4 and include the SOCF ID in the computing service request message to indicate which SOCF is selected for this request.

### UP Service Discovery in Operation 5 of FIG. 3

As described in operation 5 of FIG. 3, the SOCF may make a decision of selecting a service instance for the UE based on the information such as computing manifest, service requirements from the UE, information about the UE subscription, location, etc. Alternatively, this step can involve the UE actively participating in the selection as described in FIG. 7.

FIG. 7 illustrates a SOCF service discovery negotiation procedure in accordance with some embodiments. At operation 1, the SOCF sends a list of the discovered service instances to the UE in a computing service discovery negotiation request. The computing service discovery negotiation request may include additional information such as charging.

At operation 2, the UE selects one or multiple service instances and sends the selection results in a computing service discovery negotiation response message to the SOCF.

### UP Service Discovery in Operation 8 of FIG. 3

If in operation 5, a list of the service instances has been sent to the UE, then this information may not be included. The options described below are for the scenarios in which the SOCF made a placement decision for the UE in operation 5 of FIG. 3.

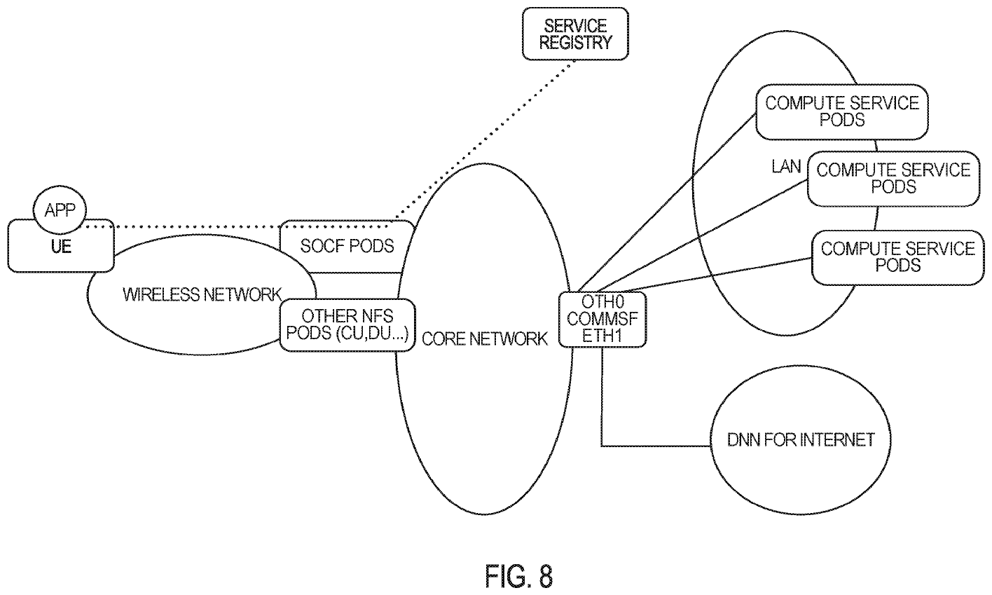

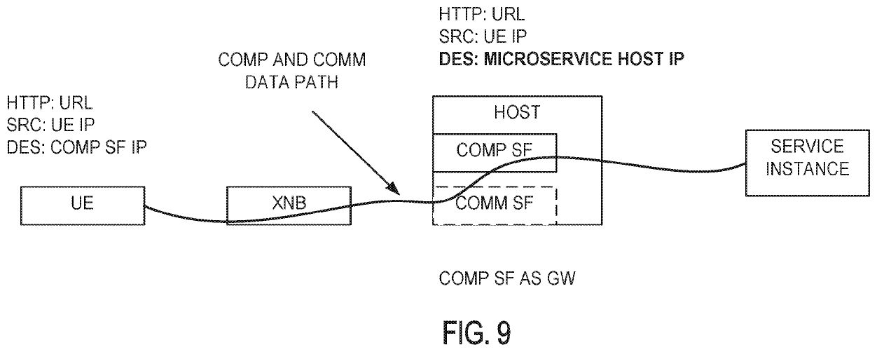

FIG. 8 illustrates a Comp SF as an ingress GW for computing services in accordance with some embodiments. FIG. 9 illustrates a Comp SF as a GW for routing UP traffic to a service instance in accordance with some embodiments. Option 1: the SOCF in operation 8 of FIG. 3 sends the ID of the selected Comp SF such as IP address: port number to the UE. In this case, Comp SF acts as a GW (e.g., ingress/egress or API GW) for the computing service instance as shown in FIG. 8. Therefore, the UE sends the data traffic in operation 9 to the selected Comp SF as shown in FIG. 9. The Comp SF filters the traffic based on the URI, so that the destination [IP address: port number] may be replaced with the service instance's [IP address: port number], which may be a private address and port number.

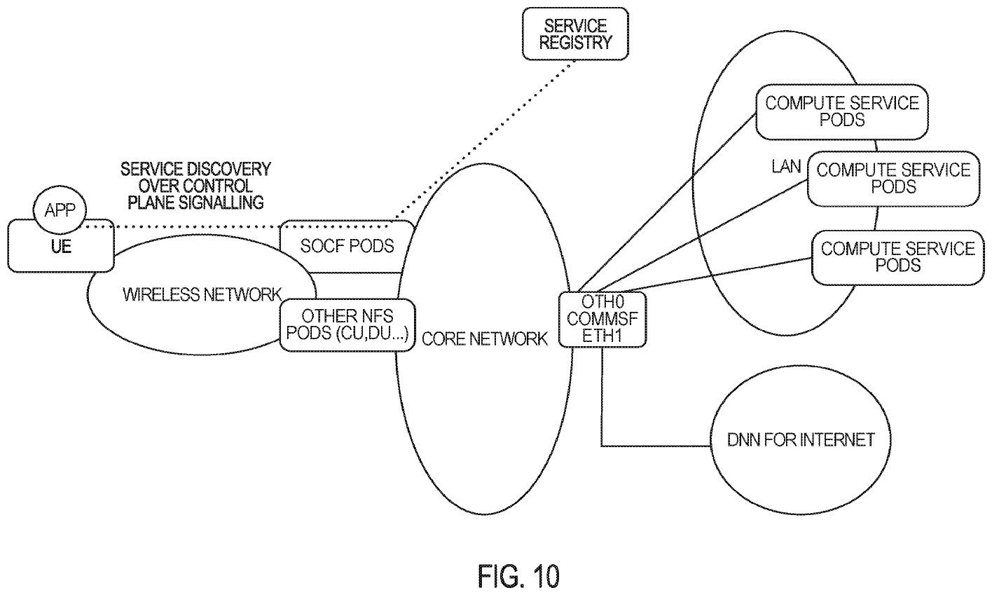

FIG. 10 illustrates a Comm SF as a GW for computing services in accordance with some embodiments. Option 2: the SOCF in operation 8 of FIG. 3 sends the ID related to the selected Comm SF to UE. The ID may be a PDU session ID, TEID, Comm SF's [IP address: port number], for example. In this case, the Comm SF acts as a GW for the computing service instance similar to Option 1 in terms of mapping the UE traffic to the [IP address: port number] of the service instance as shown in FIG. 10. To achieve this, a traffic filter and traffic rule is configured in the Comm SF to route the traffic. This traffic filter may be based on PDU session ID, TEID, the [IP address: port number] of the UE, or combination of these identifiers and configured by the Comm CF.

Option 3: the SOCF in operation 8 of FIG. 3 sends the list of the service instances to the UE as the user plane service mesh configuration if the 6G system supports service mesh. This service mesh configuration message is sent to the UE so that the subsequent computing service request may not generate a UP service discovery (such as operation 4).

Option 4: the SOCF in operation 8 of FIG. 3 sends the ID of the microservice instance directly to the UE. The ID may be, for example, the [IP address: port number] of service instances exposed to the UE. In this case, the service instance can be exposed to the UE so that the UE may send the traffic directly.

### SRF Details

As above, DNS-based service discovery has limitations, including that such discovery is not rich with meta data for services profile and cache/time-to-live (TTL)-based data. Therefore, a SRF is introduced to facilitate service discovery, by a UE, of a computing service instance and service mesh among different computing services. Similar to use of an NRF serving as the registry of control plane's network functions, the SRF in the 6G system may serve as a computing plane's registry for computing services across different domains (UE, RAN and CN).

The interactions between the SRF with other NFs such as a SOCF, Comp CF, SICF in the B5G/6G architecture are described herein. In addition, the registration of a service to a SRF are described, as is registration of a service instance register with a SRF with and without service mesh. Accordingly, a SRF is used as a service registry for 6G computing service instances to facilitate service discovery, in addition to the registration procedures for a service instance on a UE or in 6G network registration to the SRF with or without service mesh. In addition, the SRF may provide a list of service instances based on criteria in response to the UE or NF service discovery inquiries and notify a subscribed party about the status change of a service instance.

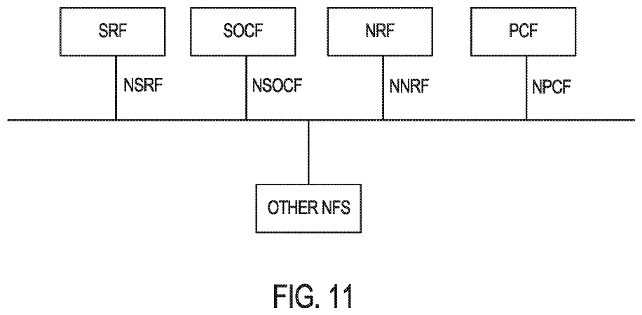

FIG. 11 illustrates a B5G/6G Core Network SBA with SRF in accordance with some embodiments. A control plane function SRF serves as a registry for computing service instances in the user plane, as shown in FIG. 11. The SRF connects to the other NFs via a service based interface (SBI) named Nsrf. For simplicity, other NFs are not completely shown.

### SRF Services and Service Operations

The services and service operations of the SRF is shown in Table 1 below. The UE may access the SRF services based on a SBI between the UE and NF. Alternatively, the UE can access the SRF services via an eSCP-C, SICF, or SOCF. These message flows are illustrated below.

TABLE 1

| | | Operation | Example |
|---|---|---|---|
| Service Name | Service Operations | Semantics | Consumer(s) |
| Nsrf_SvcI | SvcIRegister | Request/Response | NFs, UE |
| Management | SvcIUpdate | Request/Response | NFs, UE |
| | SvcIDeregister | Request/Response | NFs, UE |
| | SvcIStatusSubscribe | Subscribe/Notify | NFs, UE |
| | SvcIStatusNotify | | NFs, UE |
| | SvcIStatusUnSubscribe | | NFs, UE |
| Nsrf_SvcIDiscovery | Request | Request/Response | NFs, UE |
| Nsrf_AccessToken | Get | Request/Response | NFs, UE |

The Nsrf_SvcIManagement service handles the Service Instance (SvcI) registration, deregistration, status update, subscription to SvcI status, and notification about a status change. The Nsrf_SvcIDiscovery service handles the service discovery request for one or more SvcI with particular criteria. The Nsrf AccessToken service provides the tokens to a specific SvcI, such as a Oauth2 based access token, similar to the NRF described in 3GPP TS 23.502.

### Service Registration Procedures for Nsrf_SvcIManagement

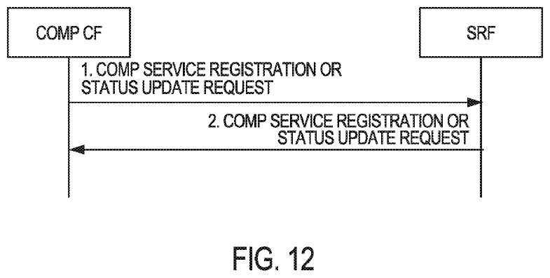

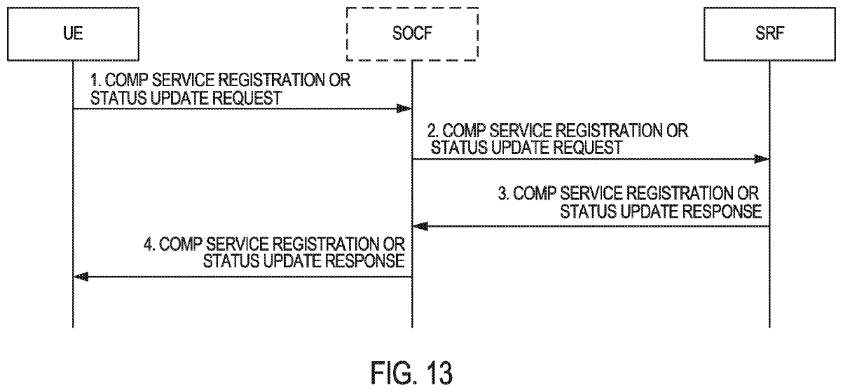

FIG. 12 illustrates computing service instance registration in a cellular network in accordance with some embodiments. FIG. 13 illustrates UE computing service registration in accordance with some embodiments. The service instances in a cellular network or on a UE registers to the SRF to create related service profiles as shown in FIGS. 12 and 13 respectively.

As shown in operation 1 of FIG. 12, when a computing instance is launched or the status is changed, the Comp CF that controls the computing infrastructure is notified as part of the computing platform capability. Specifically, the Comp CF sends a Comp service registration request or status update request to the SRF. The request includes, but is not limited to the following: 1) the information about one or more service instances such as application ID, instance ID, location, software version, publisher, size, services that the instance is providing, performance history and metrics, capability to scale up or down, etc.; 2) the requirements to use the service instance such as input format, additional authentication and authorization, data-rate, etc.; 3) the information about the Comp CF/SF that the service is related to, such as the Comp CF/SF IP address: port number, location, domain name, requirements to connect to the Comp SF, etc.; and 4) the status of the service instance, currently occupied resource of the service instance, expected running time, capacity, the meta data understandable in the same application domain . . . , etc.

At operation 2 of FIG. 12, the SRF sends a response to Comp CF to confirm the receipt of the registration message and the status of the registration (successful, failed). If registration has failed, a reason for the failure may be included in the response.

The UE may register its computing services to the SRF as shown in FIG. 13 after valid registration with the cellular network. The UE may access the SRF service directly if there is a SBI between the UE and SRF or through a SOCF.

At operation 1 of FIG. 13, the UE sends a computing service registration message or status update request to the SOCF, which can be assigned or discovered during service discovery procedure. This request may include, but is not limited to, the following information: 1) the information about one or more service instances such as application ID, instance ID, location, software version, publisher, size, services that the instance is providing, performance history and metrics, capability to scale up or down, etc.; 2) the requirements to use the service instance such as input format, additional authentication and authorization, data-rate, etc.; 3) the information about UE such as SUPI, UE's computing resource, software/hardware capabilities, etc.; 4) the status of the service instance, currently occupied resource of the service instance, expected running time, capacity, the meta data understandable in the same application domain . . . , etc.

At operation 2 of FIG. 13, the SOCF may check the UE identity, authorize the request with the UDM and decide how to process this registration request based on configured policies from the PCF. For example, the SOCF may discard the message due to the UE not being allowed to provide computing services or alter the message. In this case, the SOCF may send back a failure message to the UE. The message may also be transparent to the SOCF.

At operation 3 of FIG. 13, the SRF sends a response to the SOCF to confirm the receipt of the registration message and the status of the registration (successful, failed). If failure has occurred, a reason for the failure may be included in the response.

At operation 4 of FIG. 13, the SOCF sends a response to the UE to confirm the receipt of the registration message and the status of the registration (successful, failed). If failure has occurred, a reason for the failure may be included in the response.

In some embodiments, the SOCF may select a CompCF to handle the registration and update procedure afterwards. Thus, all the procedures are same as operation 1 of the service registration procedures for Nsrf_SvcIManagement.

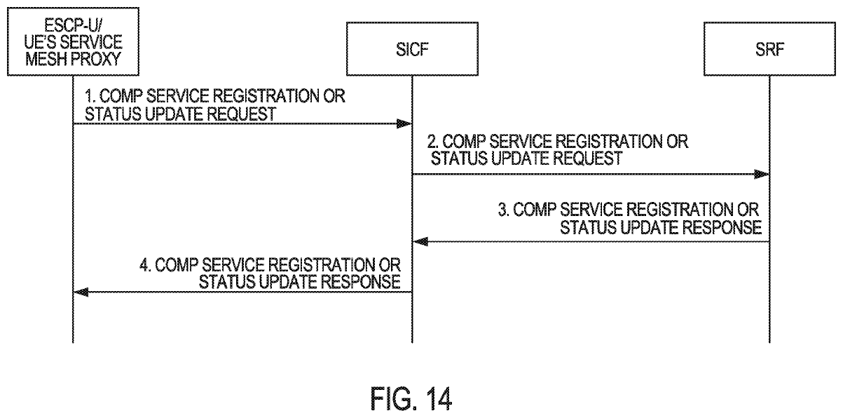

FIG. 14 illustrates SRF service registration from an SICF based on a user plane service mesh in accordance with some embodiments. In some embodiments, the service instances in the user plane may be connected by a service mesh for service to service communications. The service instance can be on a UE or in the 6G network. In this case, the eSCP-U may report SvcIs to the SICF and then trigger SvcI registration to the SRF as shown in FIG. 14.

At operation 1 in FIG. 14, the eSCP-U or UE's service mesh proxy sends a service registration or status update request to the SICF. The request includes, but is not limited to: 1) the information about one or more service instances such as application ID, instance ID, location, software version, publisher, size, services that the instance is providing, performance history and metrics, capability to scale up or down, etc.; 2) the requirements to use the service instance such as input format, additional authentication and authorization, data-rate, etc.; 3) the information about the UE such as the SUPI, UE's computing profile, capabilities, etc.; 4) the information about the Comp SF that the service is related to such as Comp SF's IP address: port number, location, domain name, requirements to connect to the Comp SF, etc.; 5) the status of the service instance, currently occupied resource of the service instance, expected running time, capacity, the meta data understandable in the same application domain . . . , etc.

At operation 2 in FIG. 14, the SICF may add additional information to the registration or status update request. The SICF sends the request to the SRF. The request contains similar information to that described in operation 1.

At operation 3 in FIG. 14, the SRF sends a response to indicate whether or not the subscription is successful. If the subscription has failed, a reason for the failure may be included in the response.

At operation 4 in FIG. 14, the SICF sends the service registration and status update response to the eSCP-U/UE's service mesh proxy to indicate the results of the registration or status update. This message can be combined with the configuration messages to the eSCP-Us or UE's service mesh proxies from the SICF and an eSCP-U or the UE's identifier can be included to indicate the recipient of the message.

### Subscription to the Status of a SvcI in SRF

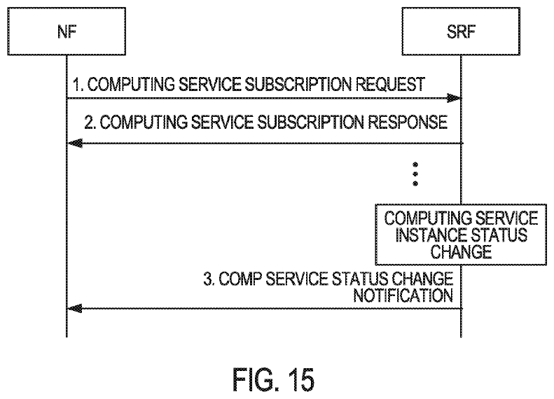

FIG. 15 illustrates computing service subscription and notification in accordance with some embodiments. The NF may subscribe to the status of a computing service instance and get notified when there is a status change as described in FIG. 15. The UE may follow FIG. 14 to obtain a subscription to go through a UE service mesh proxy to the SICF to the SRF or go through the SOCF, similar to the registration procedure in FIG. 13. The difference for the UE subscribing to a SvcI is that the SRF may check the UE subscription to determine whether the UE is allowed to consume the SRF service.

At operation 1 in FIG. 15, the NF sends a request to subscribe to the status of a service instance. The request may include, but is not limited to, the following information: the subscription criteria including identifiers of the service instance such as App ID, service name, publisher/vendor, location, Comp SF identifier, DNN, S-NSSAI, etc.; and the conditions to trigger a notification such as status change, scale up/down, etc.

At operation 2 in FIG. 15, the SRF sends a response to indicate whether or not the subscription is successful. If the subscription has failed, a reason for the failure may be included in the response.

At operation 3 in FIG. 15, when the conditions to trigger a notification are met, the SRF sends a notification message to the subscribed NF.

### Service Discovery for a Computing Service Instance Using SRF

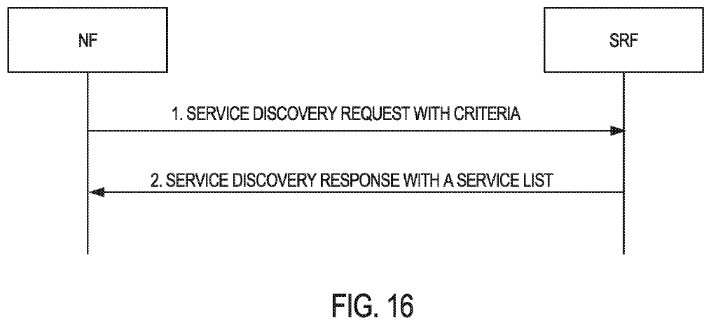

FIG. 16 illustrates SRF service discovery in accordance with some embodiments. The NF may inquire from the SRF for service discovery with specific criteria and get a list of the services from the SRF as shown in FIG. 16. The UE may follow FIG. 15 to obtain service discovery to go through a UE service mesh proxy in case of a service mesh or go through the SOCF, similar to the registration procedure in FIG. 13.

At operation 1 in FIG. 16, the NF sends a service discovery request for computing service instances to the SRF with service discovery criteria based on the information described by operation 1 of FIG. 14.

At operation 2 in FIG. 16, the SRF sends a service discovery response with the results based on the criteria in operation 1 and additional information about how to access the service instances such as the Comp SF's IP address: port number, UE ID such as SUPI, domain name and credentials, etc.

### Examples

Example 1 is an apparatus for a Service Registry Function (SRF), the apparatus comprising: memory; and processing circuitry, to configure the SRF to: connect to network functions (NFs) through a service based interface (SBI); provide a registry for computing service instances in a user plane of a user equipment (UE); and provide interaction between the computing service instances and the UE through the SBI; and wherein the memory is configured to store the computing service instances.

In Example 2, the subject matter of Example 1 includes, wherein the computing service instances comprise: a management service instance configured to: register a SRF service instance, update a status of the SRF service instance, deregister the SRF service instance, subscribe to and unsubscribe from the status of the SRF service instance, and provide notification of a change in the status of the SRF service instance, a discovery service instance configured to handle discovery requests for the SRF service, and a token service instance configured to provide a token to access the SRF service or computing service instance.

In Example 3, the subject matter of Examples 1-2 includes, wherein the processing circuitry configures the SRF to: receive, from a computing service function (Comp SF), a registration or status update request for a computing service instance, and send, to the Comp SF, a registration or status update response that indicates a status of registration of the computing service instance.

In Example 4, the subject matter of Examples 1-3 includes, wherein the processing circuitry configures the SRF to: receive, from a service orchestration and chaining function (SOCF), a registration or status update request for a computing service instance of the UE received by the SOCF, and send, to the SOCF, a registration or status update response that indicates a status of registration of the computing service instance for transmission to the UE.

In Example 5, the subject matter of Examples 1˜4 includes, wherein the processing circuitry configures the SRF to: receive, from a service infrastructure control function (SICF), a registration or status update request for a computing service instance received by the SICF from an evolved service communication proxy-user plane (eSCP-U) or a service mesh proxy of the UE, and send, to the SICF, a registration or status update response that indicates a status of registration of the computing service instance for transmission to the eSCP-U or service mesh proxy.

In Example 6, the subject matter of Examples 1-5 includes, wherein the processing circuitry configures the SRF to: receive, from a NF, a request to subscribe to a status of a computing service instance, send, to the NF, a response that indicates a status of subscription to the status of the computing service instance, and in response to successful subscription to the status of the computing service instance: determine that a trigger condition for notification of the computing service instance has been met, and send, to the NF, a notification that indicates the trigger condition of the computing service instance has been met.

In Example 7, the subject matter of Examples 1-6 includes, wherein the processing circuitry configures the SRF to: receive, from a NF, a service discovery request for computing service instances having service discovery criteria, and send, to the NF, a service discovery response that indicates computing service instances that satisfy the service discovery criteria and information about how to access the computing service instances.

Example 8 is an apparatus for a user equipment (UE), the apparatus comprising: memory; and processing circuitry, to configure the UE to: send, to one of a nth generation NodeB (xNB), access and mobility function (AMF), or Security Anchor Function (SEAF), a service registration message for service registration and authentication and authorization; perform a control plane service discovery to find a service orchestration and chaining function (SOCF); send, to the SOCF, a service request for computing service instances having service discovery criteria; receive, from the SOCF, a service response that indicates at least one computing service instance that meet the service discovery criteria and information about how to access the at least one computing service instance; and select a computing control function (Comp CF) and a computing service function (Comp SF) to set up a packet data unit (PDU) session between the UE and a selected communication service function (Comm SF) to steer traffic to the Comp SF; and wherein the memory is configured to store the at least one computing service instance that meet the service discovery criteria.

In Example 9, the subject matter of Example 8 includes, wherein the service registration message includes credentials to authenticate and authorize for a subscription to a desired computing service instance.

In Example 10, the subject matter of Examples 8-9 includes, wherein the service request includes identifiers to indicate a particular computing service instance type with computing service instance requirements.

In Example 11, the subject matter of Examples 8-10 includes, wherein: the at least one computing service instance received from the SOCF includes a plurality of computing service instances, and the processing circuitry configures the UE to: select one of the plurality of computing service instances as a selected computing service instance, and send information of the selected computing service instance to the SOCF.

In Example 12, the subject matter of Examples 8-11 includes, wherein the at least one computing service instance received from the SOCF is a single computing service instance, and the processing circuitry configures the UE to use the single computing service instance.

In Example 13, the subject matter of Examples 8-12 includes, wherein the at least one computing service instance received from the SOCF includes a new computing service instance launched by the SOCF in response to a determination that no existing computing service instance meets the service discovery criteria.

In Example 14, the subject matter of Examples 8-13 includes, wherein control plane service discovery to find the SOCF is based on one of: assignment of the SOCF to the UE during registration of the UE, an identifier of the SOCF (SOCF ID) included in a context of the UE, based on a network repository function (NRF) query, the NRF being a service registry for network functions in a 6th generation (6G) system, or based on service infrastructure control function (SICF) service mesh configuration for the UE during registration of the UE, a list of SOCF received by the UE for selection and indication of an SOCF ID of a selected SOCF in the service request.

In Example 15, the subject matter of Examples 8-14 includes, wherein user plane service discovery to find a particular service instance comprises the processing circuitry configuring the UE to receive, in the service response, one of: Comp SF identifiers, a list of the service instances as part of a user plane service mesh configuration, Comm SF identifiers, or service instance identifiers.

Example 16 is an apparatus for a service infrastructure control function (SICF), the apparatus comprising: memory; and processing circuitry, to configure the SICF to: register at least one of network functions (NFs) or computing service instances of at least one evolved service communication proxy-user plane (eSCP-U) and at least one evolved service communication proxy-control plane (eSCP-C) for a service mesh; and provide service discovery for a user equipment (UE) as part of the service mesh without use of a network repository function (NRF) or service repository function (SRF) or coordinate with the NRF and SRF to serve different UEs; and wherein the memory is configured to store the at least one of NFs or computing service instances.

In Example 17, the subject matter of Example 16 includes, wherein the processing circuitry configures the SICF to receive, during registration of the UE, a request for information of the NFs from access and mobility function (AMF) or Security Anchor Function (SEAF) and send a response to the AMF or SEAF containing the information of the NFs.

In Example 18, the subject matter of Examples 16-17 includes, wherein the processing circuitry configures the SICF to receive, in response to a request for a computing service from the UE to a service orchestration and chaining function (SOCF), a request for information of the computing service instances from the SOCF and send a response to the SOCF containing the information of the computing service instances.

In Example 19, the subject matter of Examples 16-18 includes, wherein the processing circuitry configures the SICF to receive, from the UE after establishment of the service mesh, a service mesh configuration request and send, to the UE, service discovery-related information in a service mesh configuration response.

In Example 20, the subject matter of Example 19 includes, wherein the service mesh configuration response comprises a list of service orchestration and chaining functions (SOCFs) and information about the SOCFs.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In various embodiments, an element referred to as “a”, if multiple of the elements are present may provide the functionality indicated by the element alone or in combination with the other elements (i.e., each of the elements may provide different and perhaps overlapping functionality). In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a Service Registry Function (SRF), the apparatus comprising:
processing circuitry configured to:
connect to network functions (NFs) through a service based interface (SBI);
provide a registry for computing service instances in a user plane of a user equipment (UE); and
provide interaction between the computing service instances and the UE through the SBI; and
memory configured to store the computing service instances.

22. The apparatus of claim 21, wherein the computing service instances comprise:
a management service instance configured to: register a SRF service instance, update a status of the SRF service instance, deregister the SRF service instance, subscribe to and unsubscribe from the status of the SRF service instance, and provide notification of a change in the status of the SRF service instance,
a discovery service instance configured to handle discovery requests for the SRF service instance, and
a token service instance configured to provide a token to access the SRF service instance or computing service instance.

23. The apparatus of claim 21, wherein the processing circuitry is further configured to:
decode, from a computing service function (Comp SF), a registration or status update request for a computing service instance, and
encode, for transmission to the Comp SF, a registration or status update response that indicates a status of registration of the computing service instance.

24. The apparatus of claim 21, wherein the processing circuitry is further configured to:
decode, from a service orchestration and chaining function (SOCF), a registration or status update request for a computing service instance of the UE received by the SOCF, and
encode, to the SOCF, a registration or status update response that indicates a status of registration of the computing service instance for transmission to the UE.

25. The apparatus of claim 21, wherein the processing circuitry is further configured to:
decode, from a service infrastructure control function (SICF), a registration or status update request for a computing service instance received by the SICF from an evolved service communication proxy-user plane (eSCP-U) or a service mesh proxy of the UE, and
encode, for transmission to the SICF, a registration or status update response that indicates a status of registration of the computing service instance for transmission to the eSCP-U or service mesh proxy.

26. The apparatus of claim 21, wherein the processing circuitry is further configured to:
decode, from a NF, a request to subscribe to a status of a computing service instance,
encode, to the NF, a response that indicates a status of subscription to the status of the computing service instance, and
in response to successful subscription to the status of the computing service instance:
determine that a trigger condition for notification of the computing service instance has been met, and
send, for transmission to the NF, a notification that indicates the trigger condition of the computing service instance has been met.

27. The apparatus of claim 21, wherein the processing circuitry is further configured to:
decode, from a NF, a service discovery request for computing service instances having service discovery criteria, and
encode, for transmission to the NF, a service discovery response that indicates computing service instances that satisfy the service discovery criteria and information about how to access the computing service instances.

28. An apparatus for a user equipment (UE), the apparatus comprising:
processing circuitry configured to:
encode, for transmission to one of a nth generation NodeB (xNB), access and mobility function (AMF), or Security Anchor Function (SEAF), a service registration message for service registration and authentication and authorization;
perform a control plane service discovery to find a service orchestration and chaining function (SOCF);
encode, for transmission to the SOCF, a service request for computing service instances having service discovery criteria;
decode, from the SOCF, a service response that indicates at least one computing service instance that meet the service discovery criteria and information about how to access the at least one computing service instance; and
select a computing control function (Comp CF) and a computing service function (Comp SF) to set up a packet data unit (PDU) session between the UE and a selected communication service function (Comm SF) to steer traffic to the Comp SF; and
memory configured to store the at least one computing service instance that meet the service discovery criteria.

29. The apparatus of claim 28, wherein the service registration message includes credentials to authenticate and authorize for a subscription to a desired computing service instance.

30. The apparatus of claim 28, wherein the service request includes identifiers to indicate a particular computing service instance type with computing service instance requirements.

31. The apparatus of claim 28, wherein:
the at least one computing service instance received from the SOCF includes a plurality of computing service instances, and
the processing circuitry configures the UE to:
select one of the plurality of computing service instances as a selected computing service instance, and
encode information of the selected computing service instance for transmission to the SOCF.

32. The apparatus of claim 28, wherein the at least one computing service instance received from the SOCF is a single computing service instance, and the processing circuitry configures the UE to use the single computing service instance.

33. The apparatus of claim 28, wherein the at least one computing service instance received from the SOCF includes a new computing service instance launched by the SOCF in response to a determination that no existing computing service instance meets the service discovery criteria.

34. The apparatus of claim 28, wherein control plane service discovery to find the SOCF is based on one of:
assignment of the SOCF to the UE during registration of the UE, an identifier of the SOCF (SOCF ID) included in a context of the UE,
based on a network repository function (NRF) query to an NRF, the NRF being a service registry for network functions in a 6^{th} generation (6G) system, or
based on service infrastructure control function (SICF) service mesh configuration for the UE during registration of the UE, a list of SOCF received by the UE for selection and indication of an SOCF ID of a selected SOCF in the service request.

35. The apparatus of claim 8, wherein user plane service discovery to find a particular service instance comprises the processing circuitry configuring the UE to receive, in the service response, one of: Comp SF identifiers, a list of the service instances as part of a user plane service mesh configuration, Comm SF identifiers, or service instance identifiers.

36. An apparatus for a service infrastructure control function (SICF), the apparatus comprising:
processing circuitry configured to:
register at least one of network functions (NFs) or computing service instances of at least one evolved service communication proxy-user plane (eSCP-U) and at least one evolved service communication proxy-control plane (eSCP-C) for a service mesh; and
provide service discovery for a user equipment (UE) as part of the service mesh without use of a network repository function (NRF) or service repository function (SRF) or coordinate with the NRF and SRF to serve different UEs; and
memory configured to store the at least one of NFs or computing service instances.

37. The apparatus of claim 36, wherein the processing circuitry is further configured to decode, during registration of the UE, a request for information of the NFs from access and mobility function (AMF) or Security Anchor Function (SEAF) and encode a response for transmission to the AMF or SEAF containing the information of the NFs.

38. The apparatus of claim 36, wherein the processing circuitry is further configured to decode, in response to a request for a computing service from the UE to a service orchestration and chaining function (SOCF), a request for information of the computing service instances from the SOCF and encode a response for transmission to the SOCF containing the information of the computing service instances.

39. The apparatus of claim 36, wherein the processing circuitry is further configured to decode, from the UE after establishment of the service mesh, a service mesh configuration request and encode, for transmission to the UE, service discovery-related information in a service mesh configuration response.

40. The apparatus of claim 39, wherein the service mesh configuration response comprises a list of service orchestration and chaining functions (SOCFs) and information about the SOCFs.
